(19) United States
(12) Patent Application Publication
(10) Pub. No.: US 2026/0016811 A1
(43) Pub. Date: Jan. 15, 2026

(54) DISCRETE-EVENT TRAVEL OPERATIONS WITH SPATIAL MUTUAL EXCLUSION

(71) Applicant: Autodesk, Inc., San Francisco, CA (US)

(72) Inventor: Anthony Johnson, Lehi, UT (US)

(21) Appl. No.: 18/769,276

(22) Filed: Jul. 10, 2024

(51) Int. Cl. G05B 19/4155

(52) U.S. Cl. CPC G05B 19/4155; G05B 2219/39375

(57) ABSTRACT

Methods, systems, and apparatus, including medium-encoded computer program products include: obtaining i) a simulation space comprising a grid of nodes, ii) a definition of one or more regions in the simulation space containing one or more nodes of the grid of nodes, wherein each region of the one or more regions is associated with a respective predetermined number of mobile entities allowed to be located simultaneously in the region, and iii) for each node of the grid of nodes, a region set identifier; and performing a discrete event travel simulation of two or more mobile entities without exceeding, for each region the one or more regions, the respective predetermined number of mobile entities allowed to be located simultaneously in the region.

### BACKGROUND

This specification relates to travel operations of mobile entities. Travel operations of mobile entities can be simulated using a discrete-event approach on a spatial grid of nodes.

### SUMMARY

This specification relates to travel operations of mobile entities. Travel operations of mobile entities can be simulated using a discrete-event approach on a spatial grid. The simulation can take into account the presence of exclusion regions where a predetermined number of mobile entities can be located at the same time.

In general, one or more aspects of the subject matter described in this specification can be embodied in one or more methods (and also one or more non-transitory computer-readable mediums tangibly encoding a computer program operable to cause one or more processors to perform operations), including: obtaining computer data including i) a simulation space comprising a grid of nodes, ii) a definition of one or more regions in the simulation space containing one or more nodes of the grid of nodes, wherein each region of the one or more regions is associated with a respective predetermined number of mobile entities allowed to be located simultaneously in the region, and iii) for each node of the grid of nodes, a region set identifier that identifies whether the node is contained in any of the one or more regions and, for each node of the grid of nodes that is contained in any of the one or more regions, the region set identifier identifies a set of regions of the one or more regions that contain the node, wherein a first data structure stores the region set identifier for each node of the grid of nodes; and performing a discrete event travel simulation of two or more mobile entities without exceeding, for each region the one or more regions, the respective predetermined number of mobile entities allowed to be located simultaneously in the region, wherein each mobile entity moves along a respective path on the grid of nodes, wherein performing the discrete event travel simulation includes, for a mobile entity of the one or more mobile entities moving from a current node to a next node while avoiding collisions with one or more other mobile entities, determining, using the first data structure to find both a region set identifier of the current node and a region set identifier of the next node, a set of enter regions that the mobile entity is entering and are to be allocated to the mobile entity and/or a set of exit regions that the mobile entity is exiting and are to be deallocated from the mobile entity.

One or more aspects of the subject matter described in this specification can also be embodied in one or more systems including one or more processors; and a computer-readable medium storing instructions that cause the one or more processors to perform operations including: obtaining computer data including i) a simulation space comprising a grid of nodes, ii) a definition of one or more regions in the simulation space containing one or more nodes of the grid of nodes, wherein each region of the one or more regions is associated with a respective predetermined number of mobile entities allowed to be located simultaneously in the region, and iii) for each node of the grid of nodes, a region set identifier that identifies whether the node is contained in any of the one or more regions and, for each node of the grid of nodes that is contained in any of the one or more regions, the region set identifier identifies a set of regions of the one or more regions that contain the node, wherein a first data structure stores the region set identifier for each node of the grid of nodes; and performing a discrete event travel simulation of two or more mobile entities without exceeding, for each region the one or more regions, the respective predetermined number of mobile entities allowed to be located simultaneously in the region, wherein each mobile entity moves along a respective path on the grid of nodes, wherein performing the discrete event travel simulation includes, for a mobile entity of the one or more mobile entities moving from a current node to a next node while avoiding collisions with one or more other mobile entities, determining, using the first data structure to find both a region set identifier of the current node and a region set identifier of the next node, a set of enter regions that the mobile entity is entering and are to be allocated to the mobile entity and/or a set of exit regions that the mobile entity is exiting and are to be deallocated from the mobile entity.

The region set identifier can be an index to an element of a second data structure. The element of the second data structure can contain a set of region identifiers, each region identifier corresponding to a respective region of the set of regions that contain the node. A third data structure can associate the set of region identifiers to the region set identifier.

Each mobile entity of the one or more mobile entities can be associated with an entity location variable with a value equal to the set identifier of the current node on which the mobile entity is located. Performing the discrete event simulation can include, for the mobile entity moving from the current node to the next node retrieving, using the entity location variable, a current set of region identifiers corresponding to the value of the entity location variable of the mobile entity. Performing the discrete event simulation can include, for the mobile entity moving from the current node to the next node, retrieving, using the region set identifier of the next node, a next set of region identifiers corresponding to the next node.

Determining the set of enter regions that the mobile entity is entering and are to be allocated to the mobile entity can include determining each region identifier that is contained in the next set of region identifiers and that is not contained in the current set of region identifiers. Determining the set of exit regions that the mobile entity is exiting and are to be deallocated from the mobile entity can include determining each region identifier that is contained in the current set of region identifiers and that is not contained in the next set of region identifiers, and setting the entity location variable to the set identifier of the next node.

In response to obtaining a definition of two or more regions in the simulation space, the method and/or the operations can include, for each region, for each node contained in the region, when a value stored for the node in the first data structure is a predetermined identifier indicating that the node is not contained in any one of the two or more regions, generating a set comprising the region identifier of the region and when the value stored for the node in the first data structure is a region set identifier, generating a set comprising i) the region identifier of the region and ii) a set of region identifiers retrieved from the second data structure and corresponding to the region set identifier. When the generated set is found in the third data structure, the method and/or the operations can include storing, for the node, in the first data structure, a set region identifier retrieved from the third data structure and corresponding to the generated set. When the generated set is not found in the third data structure, the method and/or the operations can include storing the generated set in a new element of the second data structure, storing, for the node, in the first data structure, a new region set identifier comprising an index to the new element of the second data structure, and associating the generated set in the third data structure to the new region set identifier.

The performing can include, when the mobile entity is moving from the current node to the next node along a diagonal of the grid of nodes, determining two or more intermediate nodes between the current node and the next node, and when at least one of the two or more intermediate nodes has a region set identifier different from the region set identifier of the current node and the next node, retrieving, for each intermediate node, a set of regions associated with the region set identifier of the intermediate node, and when the retrieved set is not contained in the set of regions associated with the region set identifier of the next node, adding the retrieved set to a diagonal set of region identifiers. Determining the set of enter regions that the mobile entity is entering and are to be allocated to the mobile entity can further include determining each region identifier that is contained in the diagonal set of region identifiers and that is not contained in the current set of region identifiers. Determining the set of exit regions that the mobile entity is exiting and are to be deallocated from the mobile entity can further include determining each region identifier that is contained in the diagonal set of region identifiers and that is not contained in the next set of region identifiers.

Obtaining the computer data including the definition of the one or more regions can include receiving a definition of a shape for each of the one or more regions in the simulation space. The method and/or the operations can include, in response to receiving the definition of the shape for each of the one or more regions, determining a bounding box of the shape, and determining, based on the bounding box, nodes of the grid of nodes contained in the region.

Particular embodiments of the subject matter described in this specification can be implemented to realize one or more of the following advantages. Grid-based travel simulations usually implement spatial mutual exclusion at a grid-node level, i.e., only one grid node can be occupied by an entity at a time. However, some applications will benefit from spatial mutual exclusion in regions larger than single grid nodes. The systems and techniques described herein can take into account the presence of regions where only a defined number of entities can be at a time. Further, the region-level mutual exclusion mechanism is implemented in a scalable way. The systems and techniques described herein can be used for planning and/or controlling travel operations of mobile entities with collision avoidance in environments with exclusion regions in which only a predetermined number of entities can be located at the same time. For example, the systems and techniques can be used for, e.g., for path planning, scheduling of operations, and/or generation of control instructions for mobile entities. Further, the system and techniques described here can also be used to analyze and improve the design of an environment where travel operations take place.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of a system usable to facilitate simulation and/or control of travel operations of mobile entities.

FIG. 2A shows an example of a simulation space for a grid-based discrete event simulation of travel operations with one exclusion region. FIG. 2B shows an example of a simulation space for a grid-based discrete event simulation of travel operations with two overlapping exclusion regions.

FIG. 3 is a flowchart of an example of a grid-based discrete-event travel simulation with region spatial mutual exclusion.

FIG. 4 is a flowchart of an example of a method performed in response to obtaining a definition of regions in the simulation space.

FIG. 5 is a flowchart of an example of a method for performing a discrete event simulation.

FIGS. 6A and 6B show examples of diagonal motion in the presence of exclusion regions.

FIG. 7 is a flowchart of an example of a method performed when a mobile entity moves along a diagonal of the grid of nodes.

FIG. 8 is a schematic diagram of a data processing system including a data processing apparatus, which can be programmed as a client or as a server, and implement the techniques described in this document.

Like reference numbers and designations in the various drawings indicate like elements.

### DETAILED DESCRIPTION

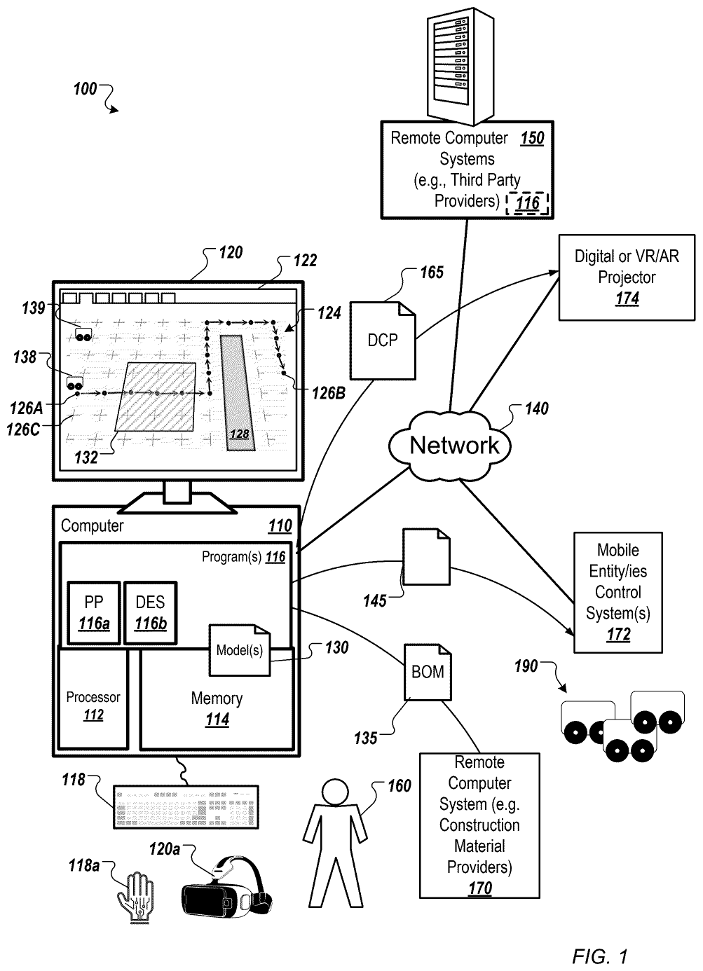

FIG. 1 shows an example of a system 100 usable to facilitate simulation and/or control of travel operations of mobile entities. For example, the mobile entities can be mobile robots, such as unmanned ground vehicles (UGVs), unmanned aerial vehicles (UAVs), unmanned surface vehicles (USVs), unmanned underwater vehicles (UUVs), etc.

A computer 110 includes a processor 112 and a memory 114. The computer 110 can be connected to a network 140, which can be a private network, a public network, a virtual private network, etc. The processor 112 can be one or more hardware processors, which can each include multiple processor cores. The memory 114 can include both volatile and non-volatile memory, such as Random Access Memory (RAM) and Flash RAM. The computer 110 can include various types of computer storage media and devices, which can include the memory 114, to store instructions of programs that run on the processor 112, including program(s) 116. Program(s) 116 can be computer aided design (CAD) and/or simulation programs and can include a path planning (PP) program 116a and a discrete-event simulation (DES) program 116b, such as a discrete-event simulation program for simulating travel operations as described herein.

As used herein, CAD refers to any suitable program used to design systems of interacting physical structures, machines, and/or devices. Program(s) 116 can include AEC (Architecture, Engineering and Construction) program(s), business and/or manufacturing system modelling program(s), etc. The program(s) 116 can model/build, analyze and/or optimize physical systems (with corresponding visualization of each physical system and activities therein) using three-dimensional (3D) and/or two-dimensional (2D) computer models and discrete event simulation. The program(s) 116 can run locally on computer 110, remotely on a computer of one or more remote computer systems 150 (e.g., one or more third party providers' one or more server systems accessible by the computer 110 via the network 140) or both locally and remotely. Thus, program(s) 116 can be two or more programs that operate cooperatively on two or more separate computer processors in that one or more programs 116 operating locally at computer 110 can offload processing operations (e.g., geometry generation and/or physical simulation operations) “to the cloud” by having one or more programs 116 on one or more computers 150 perform the offloaded processing operations. In some examples, some or all of the operations performed by PP program 116A and/or DES program 116B can be run in the cloud. In some examples, geometry generation operations can be run by one or more programs in the cloud and not in a geometry representation modeler (e.g., B-Rep modeler) that runs on the local computer. Moreover, in some implementations, the geometry generation program(s) can be run in the cloud from an Application Program Interface (API) that is called by a program, without user input through a graphical user interface.

The program(s) 116 can present a user interface (UI) 122 on a display device 120 of computer 110, which can be operated using one or more input devices 118 of the computer 110 (e.g., keyboard and mouse). Note that while shown as separate devices in FIG. 1, the display device 120 and/or input devices 118 can also be integrated with each other and/or with the computer 110, such as in a tablet computer (e.g., a touch screen can be an input/output device 118, 120). Moreover, the computer 110 can include or be part of a virtual reality (VR) and/or augmented reality (AR) system. For example, the input/output devices 118, and 120 can include VR/AR input controllers, gloves, or other hand manipulating tools 118a, and/or a VR/AR headset 120a. In some instances, the input/output devices can include hand-tracking devices that are based on sensors that track movement and recreate interaction as if performed with a physical input device. In some examples, VR and/or AR devices can be standalone devices that may not need to be connected to the computer 110. The VR and/or AR devices can be standalone devices that have processing capabilities and/or an integrated computer such as the computer 110, for example, with input/output hardware components such as controllers, sensors, detectors, etc.

In any case, a user 160 can interact with the program(s) 116 to generate and/or modify a simulation space 124 representing computer model(s) of the physical system, which can be stored in computer model document(s) 130. In the example of FIG. 1, the simulation space 124 is includes a grid of nodes such as a nodes 126A, 126B, 126C where travel operations of one or more mobile entities 138, 139 can be simulated. The grid of nodes can be a regular grid with cells of uniform size, such as a hexagonal grid or a square grid (as shown). In some examples, the grid is an irregular grid with cells of variable size and/or shape. In some examples, the grid of nodes can be a three-dimensional grid of nodes.

A user 160 or a program can define an origin node 126A and a destination node 126B for a mobile entity 138. In some instances, PP program 116A can be used to plan a trajectory and/or path for mobile entity 138. PP program 116A can use a guided path-finding algorithm such as A* algorithm (or other path-finding algorithms such as e.g., Dijkstra algorithm) to find the shortest path between origin node 126A and destination node 126B. Then, a program such as DES program 116B can be used to simulate travelling. For example, DES program 116b can be used to perform a discrete-event simulation of mobile entity 138 travelling from origin node 126A to destination node 126B following the trajectory and/or path determined by PP program 116A.

To avoid collisions, each node of the grid of nodes can be occupied by a single mobile entity at a time as they traverse the grid following their respective paths. Additionally, the user 160 or a program can define one or more exclusion regions 132 including more than one grid node. An exclusion region 132 defines a region with an associated occupation limit. For example, regions where only a predetermined number of mobile entities can be located at the same time. For example, exclusion regions 132 can correspond to a narrow passageway where only a limited number of mobile entities (e.g., only one mobile entity) can be located at the same time or a room where only a less limited number of mobile entities (e.g., two mobile entities) can maneuver at the same time. Although exclusion region 132 is depicted as a two-dimensional area in FIG. 1, exclusion regions can be three-dimensional regions. The user 160 can interact with the program(s) 116 to define a layout of an environment in the simulation space 124. For example, the user 160 can define no-entry regions 128 such as walls or other obstacles where mobile entities cannot enter when traversing the simulation space. In some instances, the no-entry regions 128 are defined by the computer model of the physical system itself, where the program(s) 116 recognize which portions of the computer model constitute walls or other obstacles where mobile entities cannot enter.

PP program 116a can be used to plan a trajectory and/or a path between origin node 126A and destination node 126B taking into account any no-entry regions such as no-entry region 128. DES program 116b can schedule events of a discrete-event simulation of motion of mobile entity 138 from node 126A to 126B according to the planned trajectory and/or path, avoiding collisions with one or more other mobile entities 139 and respecting node-level exclusion and exclusion regions 132 occupation limits.

The results of the simulation can be used to modify the environment, e.g., to change the layout of the physical system in order to improve the travel operations of the mobile entities, e.g., to reduce travel distance and/or waiting times. Once the process has finished and the user 160 is satisfied with the layout, the simulation space can be used to generate or modify a computer model document 130 containing elements that will be used in constructing the layout of the physical system. For example, a BIM (Building Information Management) model can be generated or updated. The BIM model can be used to generate a bill of materials (BOM) 135 including elements that will be used for construction. The BOM can be stored, exported to an electronic document, and/or sent to a remote computer system 170, such as for one or more construction material providers. Note that an electronic document (which for brevity will simply be referred to as a document) can be a file but does not necessarily correspond to a file. A document may be stored in a portion of a file that holds other documents, in a single file dedicated to the document in question, or in multiple coordinated files. In addition, the user 160 can save or transmit the computer model(s) for later use.

In some examples, no physical manufacturing is involved. The systems and techniques described herein are applicable to any suitable 3D modelling software. Thus, in some examples, the program(s) 116 can be animation production program(s) that render the simulation space 124 to a document 165 of an appropriate format for visual display, such as by a digital projector 174 (e.g., a digital cinema package (DCP) 165 for movie distribution) or other high resolution display device. Other applications are also possible.

In some examples, the program(s) 116 can provide a document 145 including control instructions for control system(s) 172 of one or more mobile entities 190. The control instructions can include navigation instructions, and/or trajectory scheduling so that each mobile entity performs its respective operations following a path planned by e.g., PP program 116a according to the schedule determined by DES program 116b without colliding with the one or more other mobile entities.

A discrete-event simulation can simulate long times of large operations with many interacting entities much faster than, e.g., continuous time simulations like physics-based simulations. Discrete event simulation involves the execution of time-ordered events at specific points in simulated time that change the state of a model of an entity over time. This involves managing an event queue. Events are added and removed from this queue as the simulation runs, and events have to be executed in their correct simulation time order. Maintaining this time-ordering is non-trivial. Especially for large discrete-event simulation models that include many simultaneously running processes (e.g., simulations with around 1000 or more mobile entities), the size of the event queue can become very large (e.g., the event queue can have around 10000 or more events), and the mere operation of creating an event can be computationally intensive. Thus, maintaining run-speed for complex models can be a significant challenge. Discrete-event simulation algorithms should provide accurate simulations while requiring minimal creation, sorting, execution, and removal of events from the event queue.

When simulating travel operations, a speed/distance calculation can be used to calculate the time to travel between two locations (e.g., between two nodes of a grid of nodes.) When an entity needs to travel from some origin location to some destination location, the distance between those locations (e.g., a straight-line distance calculation) can be determined and used to determine the time needed to travel to the destination. In other words, in a discrete-event simulation, an event will fire at the time when an entity needs to start traveling to a next destination. At that point, the simulation can determine the time needed to travel to the destination, e.g., by making a distance/speed calculation (travelTime=distance/speed.) Then, a new event can be created to fire at the time point (currentTime+travelTime) when the traveler will arrive at the destination.

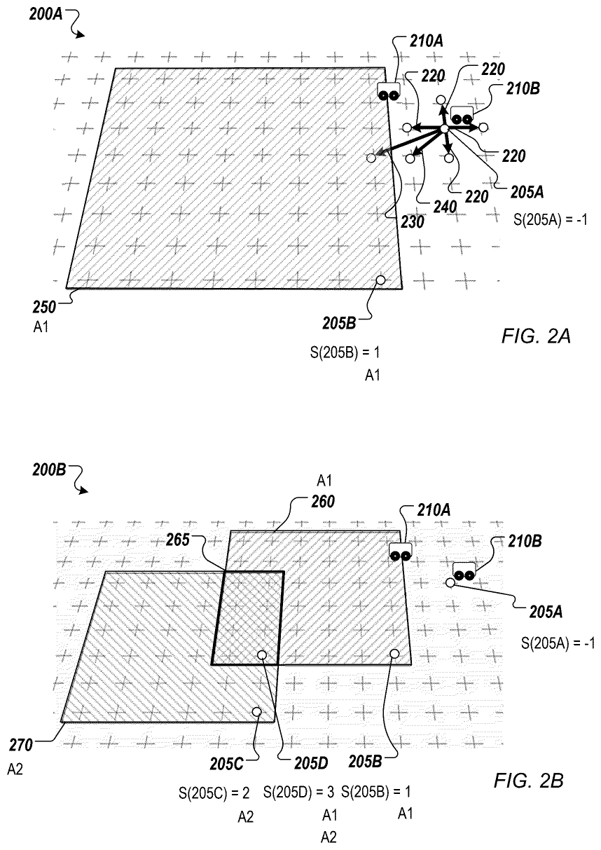

FIG. 2A shows an example of a simulation space 200A for a grid-based discrete event simulation of travel operations with one exclusion region 250. FIG. 2B shows an example of a simulation space 200B for a grid-based discrete event simulation of travel operations with two overlapping exclusion regions 260, 270.

In grid-based settings, such as in FIG. 2A, a path-finding algorithm can be used to move an entity 210B between locations on a grid of nodes. In some examples, when an entity 210B plans a travel operation from an origin node (e.g., node 205A) to a destination node (e.g., node 205B), a path to the destination can first be resolved, and then the entity can travel the pre-planned path using an event-based approach. Resolving the path to the destination involves finding a sequence of grid nodes to the destination using a path-finding algorithm, e.g., a guided path-finding algorithm such as A*. Then, the time to travel this path can be calculated based on a speed of the entity and the distance between nodes. Future events required to move the entity along the path from the origin to the destination can then be created and executed.

In the example of FIG. 2A, nodes are arranged in a square grid. In some examples, entities can travel between nodes that are vertically or horizontally adjacent. In other words, entities can travel in four directions 220: up, down, left, or right. In some examples, entities are allowed to travel diagonally. When entities would otherwise travel horizontally and then vertically or vice versa, they are allowed to shorten travel by traveling along a diagonal such as diagonal 240. This allows entities to travel in up to eight directions instead of only four directions. In some examples, entities are allowed to travel along “deep diagonals,” such as deep diagonal 230, traversing diagonally two grid nodes vertically and one horizontally, or vice versa. This allows entities to travel in up to sixteen directions, instead of only eight directions.

In a scenario in which interactions between multiple entities 210A, 210B can be ignored, the most efficient method for performing a travel operation would be to calculate a total travel distance over the grid-based path from origin to destination and create a single event at the time it takes for the entity to get to the destination along the grid-based path. Although the path-finding algorithm is non-trivial, the discrete-event simulation requires a single event creation.

However, in most discrete-event simulation scenarios, interactions between multiple entities are important to simulating valid travel operations. High traffic regions create slowdowns that cause longer travel times, which are important for performing a valid simulation analysis of a system.

Discrete-event simulations can use allocation schemes on the grid of nodes to avoid collisions between entities or, in other words, to enforce space-based mutual exclusion of entities. To implement space-based mutual exclusion of entities at node-level, each node in the grid can only be allocated to one entity at a time and an entity cannot travel to a grid node until it has allocated that grid node. This keeps entities from colliding with each other through spatial mutual exclusion since it prevents entities from being on the same grid node at the same time.

In some examples, an allocation scheme can be implemented that fires an event every time a node needs to be allocated. First, the grid-based path from an origin node to a destination node can be calculated. Then, while the entity's current node is not the destination grid node, the entity tries to allocate the next node in the path, waiting at the current node until the next node can be allocated. To travel to the next node, the time to travel to the next node can be calculated, e.g., as distance/speed. The current node can then be deallocated (or an event to deallocate it with some offset time or distance required to clear the node can be created.) An event is created for the arrival time at the next node. When the arrival event executes, the entity's current node is updated to the next node.

In this type of allocation scheme, an event is fired every time a grid node needs to be allocated. If the entity cannot allocate the next node immediately, it will stop at its current node until it can allocate it. An event is created and executed on arrival at every grid node. Especially when grids are sparsely populated by entities, most of the time an entity will immediately allocate the next node. In sparsely-populated grids, most of the time an entity could have travelled most of the time without allocations, thus avoiding unnecessary intermediate event generation.

Alternatively, an allocation scheme based on allocation scheduling can be implemented. This allocation scheme can be more event-efficient, especially for grids that are sparsely populated. After path-finding is finished, an entity can “look ahead” through the planned path, calculating when it will arrive at each node based on its speed and inter-node distances. Then the entity can attempt to schedule allocation of each node along the path. This involves trying to allocate the node for a certain time slot. A grid node structure can track which entities are going to allocate which node at which times in the future. As long as there are no time collisions between the allocations (i.e., no allocations of different entities on the same grid node overlapping in time), the entity can schedule all the allocations for its entire path and create a single event for the arrival at the destination. On the other hand, if the allocation scheduling loop finds a time collision, the entity will create an event for when the time collision happens, and then stop just before the collision node and wait until it can allocate the node.

This allocation scheme can be more event-efficient than the event-heavy algorithm described above. Especially in sparsely populated grids the number of events that must be created can be orders of magnitude smaller. Events are only created when an allocation fails (i.e., when an entity must wait for another entity to deallocate a node) or when the traveler finishes the travel operation.

In any case, standard grid-based travel simulation algorithms usually implement spatial mutual exclusion at a grid-node level, i.e., only one grid node can be allocated at a time. However, some applications can benefit from mutual exclusion in regions larger than single grid nodes. The systems and techniques described herein allow users to specify regions including more than one grid node where only a defined number of entities (e.g., one entity) can be at a time. The system and techniques described herein introduce a versatile spatial mutual exclusion mechanism that can be implemented in a scalable way for discrete-element based travel simulations.

For example, an exclusion region such as exclusion region 250 shown in FIG. 2A can be defined. For any one of mobile entities 210A, 210B to travel to any grid node inside exclusion region 250, such as grid node 205B, the entity must first allocate the entire exclusion region 250.

In some examples, as shown in FIG. 2B, more than one exclusion region 260, 270 can be defined in a simulation space 200B. The number of entities that can be in any of the exclusion regions at the same time can be a predetermined number defined by the user. In some examples, exclusion regions 260, 270 can overlap in an overlapping region 265. For any mobile entity to travel to any grid node that is contained by two exclusion regions, such as grid node 205D, the entity must allocate both regions 260, 270. The number of mobile entities that can be at a time in a region 265 where exclusion regions 260, 270 overlap is determined by the minimum of the number of entities that can be in any of the overlapping exclusion regions.

Exclusion region entry and exit can be detected by storing data on the grid nodes themselves (or in a data structure storing grid node data) regarding which exclusion regions those grid nodes are in. During the path traversal phase of a travel operation, it can be quickly detected which exclusion regions a mobile entity is entering and which exclusion regions it is exiting. Then, appropriate events can be created to allocate the exclusion region(s) that the entity needs to enter and deallocate the exclusion region(s) that it exits.

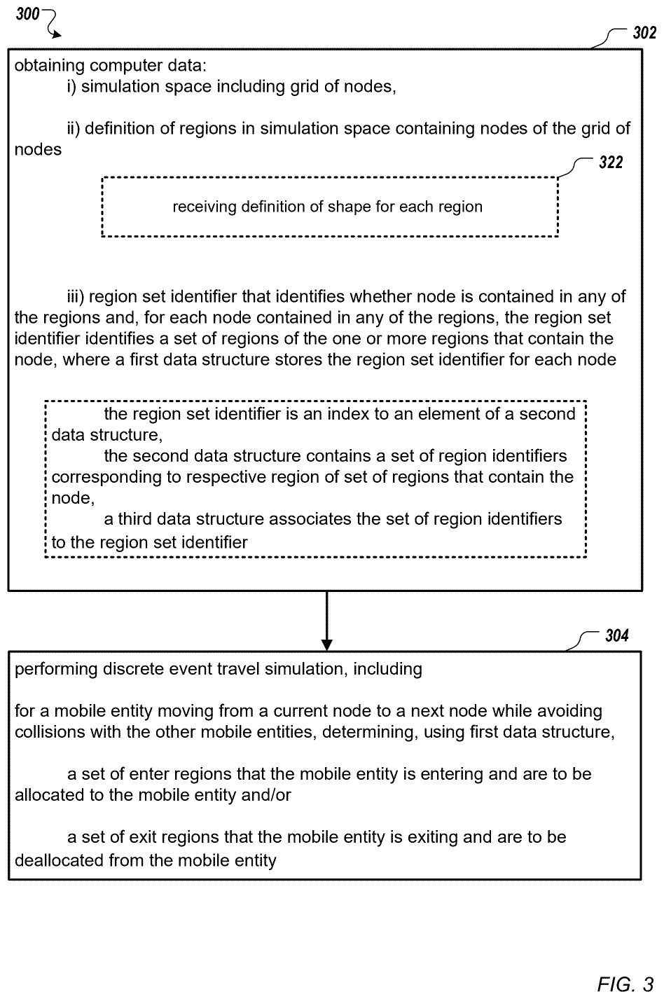

FIG. 3 is a flowchart of an example of a grid-based discrete-event travel simulation with region spatial mutual exclusion. At 302, computer data is obtained. A simulation space comprising a grid of nodes, such as simulation space 200A in FIG. 2A or simulation space 200B in FIG. 2B, can be obtained, e.g., received from another program, loaded from persistent storage, or generated from a computer model of a physical system. The simulation space can be a two-dimensional or a three-dimensional simulation space.

A definition of one or more regions in the simulation space containing one or more nodes of the grid of nodes, such as exclusion region 250 in FIG. 2A or exclusion regions 260, 270 in FIG. 2B, can also be obtained at 302, e.g., received from another program, loaded from persistent storage, or received from a user who is working with a computer model of a physical system in a graphical user interface of a computer. In some examples, the exclusion regions include two or more nodes of the grid of nodes. Each region of the one or more regions can be associated with a respective predetermined number of mobile entities allowed to be located simultaneously in the region. In some examples, only one mobile entity may be allowed in some of the exclusion regions.

In some examples, a user or a program can provide a selection of grid nodes that are contained in each exclusion region. In some examples, at 322 a definition of a shape for each of the one or more regions in the simulation space can be received, e.g., from the user.

For each node of the grid of nodes, a region set identifier can be obtained at 302, e.g., received from another program, loaded from persistent storage, or generated from the one or more exclusion regions as defined in relation to the simulation space and/or the computer model of the physical system. The region set identifier identifies whether the node is contained in any of the one or more regions. For example, the region set identifier can take a predetermined value when the node is not contained in any one of the one or more regions. In the examples of FIGS. 2A, 2B, node 205A has a region set identifier set to −1, which in this example indicates that the node is not contained in any one of the one or more regions.

For each node of the grid of nodes that is contained in any of the one or more regions, the region set identifier identifies a set of regions of the one or more regions that contain the node. For example, in FIG. 2B, node 205B is contained in region 260 and its associated region set identifier is set to 1. Node 205C is contained in region 270 and its associated region set identifier is set to 2. Node 205D is contained in region 260 and in region 270 and its associated region set identifier is set to 3. A first data structure, e.g., data structure S in FIGS. 2A or 2B can store the region set identifier for each node of the grid of nodes. Although in this example the region set identifiers take integer values, the region set identifier can take other values, i.e., character or string values.

Each exclusion region can also be associated with a region identifier. For example, the region identifier can be an integer or an integer alias. The exclusion regions can be looked up efficiently using the identifier. For example, the first added exclusion region can get a first identifier, the second added exclusion area can get a second identifier, etc. In the example of FIG. 2B, exclusion region 260 is associated with region identifier A1 and exclusion region 270 is associated with region identifier A2.

The region set identifier can be an index to an element of a second data structure, where the element of the second data structure contains a set of region identifiers, each region identifier corresponding to a respective region of the set of regions that contain the node. For example, following with the example of FIG. 2B, the element of the second data structure corresponding to region set identifier I can contain region identifier A1. The element of the second data structure corresponding to region set identifier 2 can contain region identifier A2. The element of the second data structure corresponding to region set identifier 3 can contain region identifiers A1, A2.

The second data structure can be an array, a hashmap, etc. For example, the system can keep a global array (e.g., a std::vector in C++) with the sets of region identifiers that represent all of the encountered sets of exclusion areas associated with any grid node. For example, in C++, this can be defined as std::vector<std::set<regionIdentifier>>. The region set identifier of each grid node can be an index into the element of this global array that represents the set of exclusion regions that the grid node is contained by.

A third data structure can be maintained to associate the set of region identifiers to the region set identifier. Following with the example of FIG. 2B, a third data structure can be maintained that can use the different sets of region identifiers, i.e., [A1], [A1, A2], [A2] as key values to retrieve their respective region set identifier, i.e., 1, 2, 3. Whenever a new set of regions is added to the second data structure, the third data structure is updated with an entry that references that set in the second data structure.

For example, if the region identifiers are integers and the system keeps a global array, a global quick lookup associative array can map from each integer set to a corresponding integer index in the global array of sets. For example, in C++ this can be defined as a std::unordered_map<std::set<regionIdentifier>, size_t>. Whenever a new set is added to the global set array, this map is updated with an entry that references that set in the array.

At 304, a discrete event travel simulation of two or more mobile entities can be performed without exceeding, for each region the one or more regions, the respective predetermined number of mobile entities allowed to be located simultaneously in each region. Each mobile entity can move along a respective path on the grid of nodes that can be planned according to a path-finding algorithm.

Performing the discrete event travel simulation can include, for a mobile entity of the one or more mobile entities moving from a current node to a next node while avoiding collisions with the one or more other mobile entities, determining, using the first data structure to find both a region set identifier of the current node and a region set identifier of the next node, a set of enter regions that the mobile entity is entering and are to be allocated to the mobile entity and/or a set of exit regions that the mobile entity is exiting and are to be deallocated from the mobile entity. For example, in FIG. 2B, mobile entity 210A will detect that the region set identifier of its next node is set to 1 and thus exclusion area A1 has to be allocated.

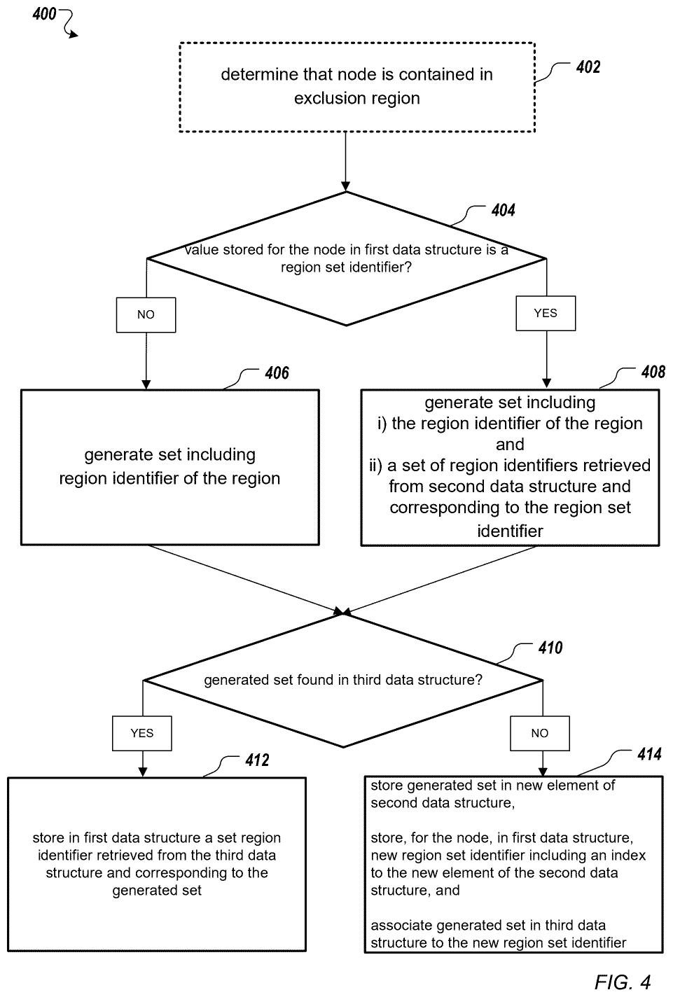

FIG. 4 is a flowchart of an example of a method 400 performed in response to obtaining a definition of regions in the simulation space. The region set identifier of each node can be set to a predetermined value indicating that the node is not contained in any one of the two or more regions. For example, the region set identifier can be set to −1, meaning no exclusion region contains the node. The second and third data structures can also be cleared. The operations of method 400 can be performed for each exclusion region, and for each node contained in the exclusion region.

In some examples, in response to receiving the definition of the shape for each of the one or more regions, a bounding box of the shape can be determined. Based on the bounding box, nodes of the grid of nodes contained in the region can be determined.

In some examples, a model-builder can be used to define a two-dimensional or a three-dimensional shape within the simulation space to define each exclusion region. For example, the shape can be any shape for which i) a bounding box can be calculated, and ii) for which, given some point in the simulation space, it can be determined whether the point is inside the shape.

In some examples, to determine if a node is contained in the exclusion region, the bounding box of the exclusion region can be used. In some examples, the bounding box can be used to determine an axis-aligned bounding box. For example, an axis-aligned bounding box can be a bounding box whose sides are aligned with respect to the simulation space. A minimum node and maximum node with respect to the axis-aligned bounding box can be determined. Each grid node from the minimum to the maximum grid nodes within the axis-aligned bounding box can be traversed and tested to determine if it is contained in the exclusion region.

Regardless of how it is determined 402 that the node is contained in the exclusion region, a set representing the set of so-far encountered exclusion regions containing that grid node is created. At 404 the value stored for the node in the first data structure is checked.

If a value stored for the node in the first data structure is a predetermined identifier indicating that the node is not contained in any one of the two or more regions (e.g., “−1”), a set including the region identifier of the region is generated at 406.

If the value stored for the node in the first data structure is a region set identifier, a set is generated at 408 including i) the region identifier of the region and ii) a set of region identifiers retrieved from the second data structure and corresponding to the region set identifier. For example, a copy of the retrieved set can be created and the region identifier for the region can be added to the set.

At 410, the generated set is looked up in the third data structure. If the generated set is found in the third data structure, at 412 the method stores, for the node, in the first data structure, a set region identifier retrieved from the third data structure and corresponding to the generated set. If the generated set is not found in the third data structure, the generated set is stored in a new element of the second data structure at 414. In the first data structure, a new region set identifier for the node is stored including an index to the new element of the second data structure. The generated set in the third data structure is associated to the new region set identifier.

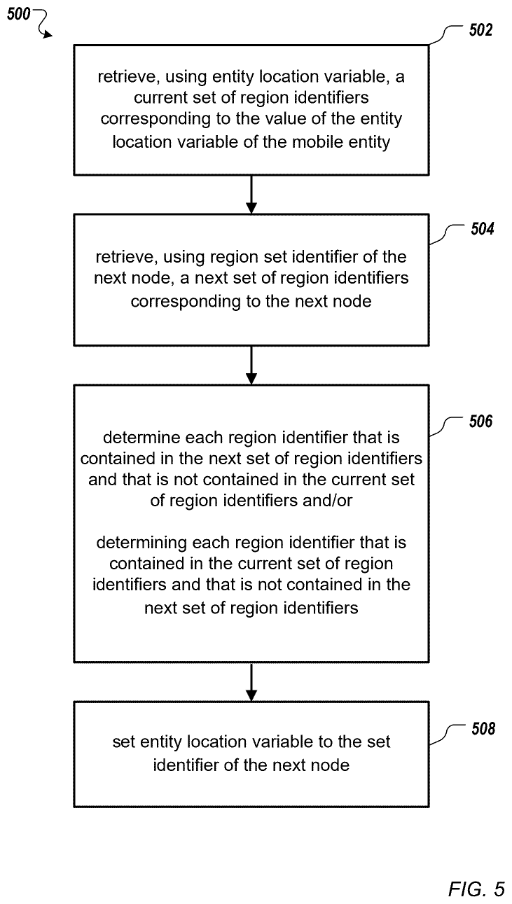

FIG. 5 is a flowchart of an example of a method 500 for performing a discrete event simulation. Each mobile entity of the one or more mobile entities can be associated with an entity location variable with a value equal to the set identifier of the current node on which the mobile entity is located. Performing the discrete event simulation can include, for the mobile entity moving from the current node to the next node, determining if the next node region set identifier is different than a value of the entity location variable.

If the next node region set identifier is different than the entity location variable, the method retrieves 502, using the entity location variable, a current set of region identifiers corresponding to the value of the entity location variable of the mobile entity and also retrieves, at 504, using the region set identifier of the next node, a next set of region identifiers corresponding to the next node.

Determining the set of enter regions that the mobile entity is entering and are to be allocated to the mobile entity includes determining 506 each region identifier that is contained in the next set of region identifiers and that is not contained in the current set of region identifiers. Determining the set of exit regions that the mobile entity is exiting and are to be deallocated from the mobile entity includes determining 506 each region identifier that is contained in the current set of region identifiers and that is not contained in the next set of region identifiers.

If there are exclusion areas to enter or exit, the appropriate events that allocate or deallocate those exclusion areas can be created. At 508 the entity location variable is set to the region set identifier of the next node. Using this method of exclusion region entry/exit detection, it can be detected at which points along its path a mobile entity will enter/exit any exclusion areas in a computationally efficient manner.

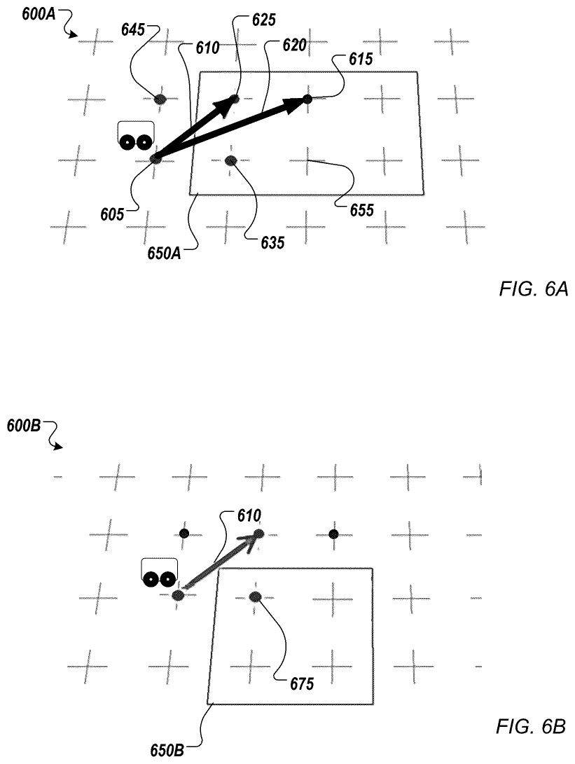

FIGS. 6A and 6B show examples of diagonal motion in the presence of exclusion regions. If diagonal travel is allowed, the allocation scheme can be adapted accordingly. When a traveler is traveling diagonally, additional intermediate nodes are allocated, where the “intermediate” nodes are the set of nodes of which at least one such node would need to be traveled to achieve the shortest path between the first and second nodes when no diagonal motion is allowed. For example, when moving along diagonal 610 from node 605 to node 625, besides allocating node 625 additional intermediate nodes 635 and 645 can be allocated since one of these two nodes must be travelled in a non-diagonal-motion environment in order to get from node 605 to node 625. When moving along deep diagonal 620 from node 605 to node 615, besides allocating node 615 additional intermediate nodes 625 and 635 can be allocated. In other examples, additional intermediate nodes can be allocated when travelling along deep diagonals, e.g., nodes 645 and/or 655, depending on the size of the mobile entities in relation to the resolution of the gride of nodes and rules used by the DES program 116b.

Allocation timing for the additional nodes can be the same as allocation timing for the next diagonal node. Deallocation of the additional nodes can be earlier than deallocation of the target diagonal node.

When an entity travels in a diagonal 610 or a deep diagonal 620, it traverses the grid between the additional nodes in traveling from the current node to the next node. If the set of exclusion areas containing the additional nodes is either the same as that of the current node or the same as that of the next node, as in the example of FIG. 6A, the method can proceed as described with reference to FIG. 5 and, generating the appropriate events for entering/exiting exclusion regions, such as exclusion region 650A in simulation space 600A in FIG. 6A. However, if any of the additional nodes has a exclusion region set different than that of the current node and that of the next node, such as intermediate node 675 in exclusion region 650B in simulation space 600B in FIG. 6B, the method is adjusted.

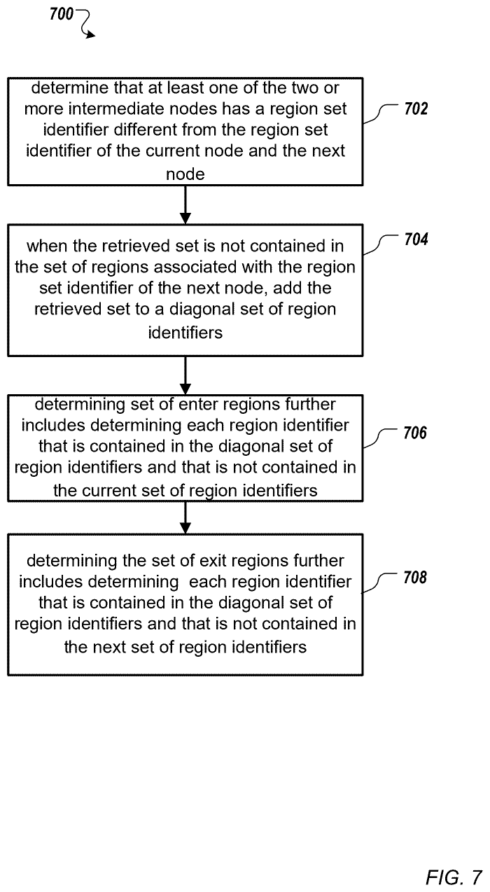

FIG. 7 is a flowchart of an example of a method 700 performed when a mobile entity is moving from the current node to the next node along a diagonal of the grid of nodes. Two or more intermediate nodes between the current node and the next node are determined. When it is determined 702 that at least one of the two or more intermediate nodes has a region set identifier different from the region set identifier of the current node and the next node, the next operations of the method are performed.

At 704, the method retrieves, for each intermediate node, a set of regions associated with the region set identifier of the intermediate node. When the retrieved set is not contained in the set of regions associated with the region set identifier of the next node, the retrieved set is added to a diagonal set of region identifiers at 704.

Determining the set of enter regions that the mobile entity is entering and are to be allocated to the mobile entity further includes determining 706 each region identifier that is contained in the diagonal set of region identifiers and that is not contained in the current set of region identifiers. Determining the set of exit regions that the mobile entity is exiting and are to be deallocated from the mobile entity further includes determining 708 each region identifier that is contained in the diagonal set of region identifiers and that is not contained in the next set of region identifiers. With this adjustment to the algorithm when detecting entry/exit, the algorithm can properly simulate entry and exit of exclusion regions when traveling along diagonals of the grid of nodes.

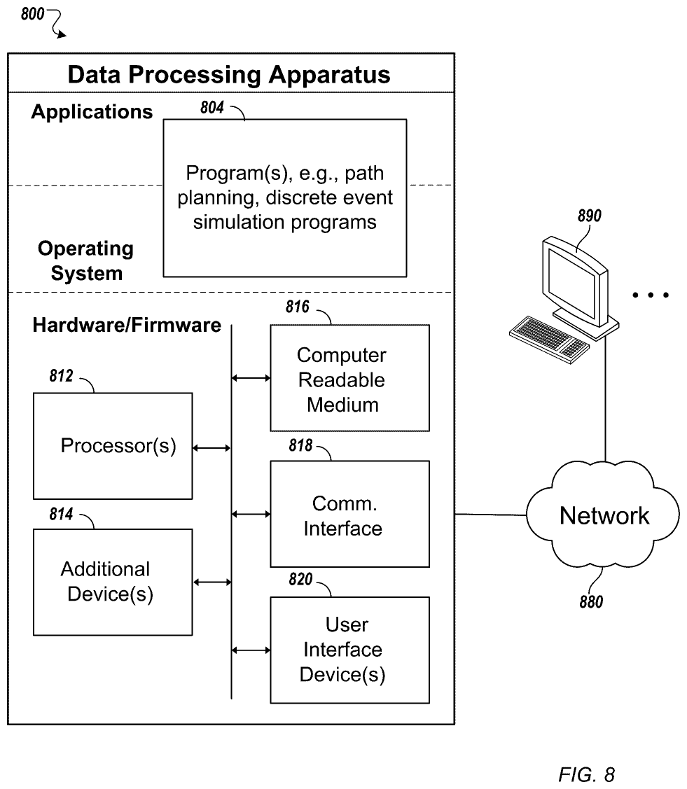

FIG. 8 is a schematic diagram of a data processing system including a data processing apparatus 800, which can be programmed as a client or as a server. The data processing apparatus 800 is connected with one or more computers 890 through a network 880. While only one computer is shown in FIG. 8 as the data processing apparatus 800, multiple computers can be used. The data processing apparatus 800 includes various software modules, which can be distributed between an applications layer and an operating system. These can include executable and/or interpretable software programs or libraries, including tools and services of one or more programs 804 that implement trajectory and/or path planning, and/or discrete-event simulations, as described above. Thus, the program(s) 804 can be program(s) 116 (such as path planning program(s) 116a and discrete event simulation program(s) 116b) and can implement one or more grid-based discrete-event simulation of travel operations with one or more exclusion regions. Further, the program(s) 804 can potentially implement one or more of generation of control instructions (path navigation and/or trajectory scheduling) for mobile entities, control of operations of mobile entities, room layout design and/or improvement, or BOM generation. The number of software modules used can vary from one implementation to another. Moreover, the software modules can be distributed on one or more data processing apparatus connected by one or more computer networks or other suitable communication networks.

The data processing apparatus 800 also includes hardware or firmware devices including one or more processors 812, one or more additional devices 814, a computer readable medium 816, a communication interface 818, and one or more user interface devices 820. Each processor 812 is capable of processing instructions for execution within the data processing apparatus 800. In some examples, the processor 812 is a single or multi-threaded processor. Each processor 812 is capable of processing instructions stored on the computer readable medium 816 or on a storage device such as one of the additional devices 814. The data processing apparatus 800 uses the communication interface 820 to communicate with one or more computers 890, for example, over the network 880. Examples of user interface devices 820 include a display, a camera, a speaker, a microphone, a tactile feedback device, a keyboard, a mouse, and VR and/or AR equipment. The data processing apparatus 800 can store instructions that implement operations associated with the program(s) described above, for example, on the computer readable medium 816 or one or more additional devices 814, for example, one or more of a hard disk device, an optical disk device, a tape device, and a solid state memory device.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a non-transitory computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, e.g., after delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display) display device, an OLED (organic light emitting diode) display device, or another monitor, for displaying information to the user, and a keyboard and a pointing device, e.g., a mouse or a trackball, by which the user can provide input to the computer. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a browser user interface through which a user can interact with an implementation of the subject matter described is this specification, or any combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. In addition, actions recited in the claims can be performed in a different order and still achieve desirable results.

What is claimed is:

1. A method performed by a data processing apparatus, the method comprising:
obtaining computer data comprising
i) a simulation space comprising a grid of nodes,
ii) a definition of one or more regions in the simulation space containing one or more nodes of the grid of nodes, wherein each region of the one or more regions is associated with a respective predetermined number of mobile entities allowed to be located simultaneously in the region, and
iii) for each node of the grid of nodes, a region set identifier that identifies whether the node is contained in any of the one or more regions and, for each node of the grid of nodes that is contained in any of the one or more regions, the region set identifier identifies a set of regions of the one or more regions that contain the node, wherein a first data structure stores the region set identifier for each node of the grid of nodes; and
performing a discrete event travel simulation of two or more mobile entities without exceeding, for each region the one or more regions, the respective predetermined number of mobile entities allowed to be located simultaneously in the region, wherein each mobile entity moves along a respective path on the grid of nodes, wherein performing the discrete event travel simulation comprises, for a mobile entity of the one or more mobile entities moving from a current node to a next node while avoiding collisions with one or more other mobile entities,
determining, using the first data structure to find both a region set identifier of the current node and a region set identifier of the next node, a set of enter regions that the mobile entity is entering and are to be allocated to the mobile entity and/or a set of exit regions that the mobile entity is exiting and are to be deallocated from the mobile entity.

2. The method of claim 1, wherein the region set identifier is an index to an element of a second data structure, wherein the element of the second data structure contains a set of region identifiers, each region identifier corresponding to a respective region of the set of regions that contain the node; and
wherein a third data structure associates the set of region identifiers to the region set identifier.

3. The method of claim 1, wherein each mobile entity of the one or more mobile entities is associated with an entity location variable with a value equal to the set identifier of the current node on which the mobile entity is located; and
wherein performing the discrete event simulation comprises, for the mobile entity moving from the current node to the next node
retrieving, using the entity location variable, a current set of region identifiers corresponding to the value of the entity location variable of the mobile entity,
retrieving, using the region set identifier of the next node, a next set of region identifiers corresponding to the next node,
wherein determining the set of enter regions that the mobile entity is entering and are to be allocated to the mobile entity comprises determining each region identifier that is contained in the next set of region identifiers and that is not contained in the current set of region identifiers,
wherein determining the set of exit regions that the mobile entity is exiting and are to be deallocated from the mobile entity comprises determining each region identifier that is contained in the current set of region identifiers and that is not contained in the next set of region identifiers, and
setting the entity location variable to the set identifier of the next node.

4. The method of claim 2, wherein, in response to obtaining a definition of two or more regions in the simulation space, the method comprises, for each region:
for each node contained in the region,
when a value stored for the node in the first data structure is a predetermined identifier indicating that the node is not contained in any one of the two or more regions, generating a set comprising the region identifier of the region,
when the value stored for the node in the first data structure is a region set identifier, generating a set comprising i) the region identifier of the region and ii) a set of region identifiers retrieved from the second data structure and corresponding to the region set identifier,
when the generated set is found in the third data structure,
storing, for the node, in the first data structure, a set region identifier retrieved from the third data structure and corresponding to the generated set; and,
when the generated set is not found in the third data structure,
storing the generated set in a new element of the second data structure,
storing, for the node, in the first data structure, a new region set identifier comprising an index to the new element of the second data structure, and
associating the generated set in the third data structure to the new region set identifier.

5. The method of claim 1, wherein the performing comprises, when the mobile entity is moving from the current node to the next node along a diagonal of the grid of nodes,
determining two or more intermediate nodes between the current node and the next node, and
when at least one of the two or more intermediate nodes has a region set identifier different from the region set identifier of the current node and the next node,
retrieving, for each intermediate node, a set of regions associated with the region set identifier of the intermediate node, and
when the retrieved set is not contained in the set of regions associated with the region set identifier of the next node, adding the retrieved set to a diagonal set of region identifiers,
wherein determining the set of enter regions that the mobile entity is entering and are to be allocated to the mobile entity further comprises determining each region identifier that is contained in the diagonal set of region identifiers and that is not contained in the current set of region identifiers, and
wherein determining the set of exit regions that the mobile entity is exiting and are to be deallocated from the mobile entity further comprises determining each region identifier that is contained in the diagonal set of region identifiers and that is not contained in the next set of region identifiers.

6. The method of claim 1, wherein obtaining the computer data comprising the definition of the one or more regions comprises receiving a definition of a shape for each of the one or more regions in the simulation space, and wherein the method comprises, in response to receiving the definition of the shape for each of the one or more regions,
determining a bounding box of the shape, and
determining, based on the bounding box, nodes of the grid of nodes contained in the region.

7. A system comprising:
one or more processors; and
a computer-readable medium storing instructions that cause the one or more processors to perform operations comprising:
obtaining computer data comprising
i) a simulation space comprising a grid of nodes,
ii) a definition of one or more regions in the simulation space containing one or more nodes of the grid of nodes, wherein each region of the one or more regions is associated with a respective predetermined number of mobile entities allowed to be located simultaneously in the region, and
iii) for each node of the grid of nodes, a region set identifier that identifies whether the node is contained in any of the one or more regions and, for each node of the grid of nodes that is contained in any of the one or more regions, the region set identifier identifies a set of regions of the one or more regions that contain the node, wherein a first data structure stores the region set identifier for each node of the grid of nodes; and
performing a discrete event travel simulation of two or more mobile entities without exceeding, for each region the one or more regions, the respective predetermined number of mobile entities allowed to be located simultaneously in the region, wherein each mobile entity moves along a respective path on the grid of nodes, wherein performing the discrete event travel simulation comprises, for a mobile entity of the one or more mobile entities moving from a current node to a next node while avoiding collisions with one or more other mobile entities,
determining, using the first data structure to find both a region set identifier of the current node and a region set identifier of the next node, a set of enter regions that the mobile entity is entering and are to be allocated to the mobile entity and/or a set of exit regions that the mobile entity is exiting and are to be deallocated from the mobile entity.

8. The system of claim 7, wherein the region set identifier is an index to an element of a second data structure, wherein the element of the second data structure contains a set of region identifiers, each region identifier corresponding to a respective region of the set of regions that contain the node; and
wherein a third data structure associates the set of region identifiers to the region set identifier.

9. The system of claim 7, wherein each mobile entity of the one or more mobile entities is associated with an entity location variable with a value equal to the set identifier of the current node on which the mobile entity is located; and
wherein performing the discrete event simulation comprises, for the mobile entity moving from the current node to the next node
retrieving, using the entity location variable, a current set of region identifiers corresponding to the value of the entity location variable of the mobile entity,
retrieving, using the region set identifier of the next node, a next set of region identifiers corresponding to the next node,
wherein determining the set of enter regions that the mobile entity is entering and are to be allocated to the mobile entity comprises determining each region identifier that is contained in the next set of region identifiers and that is not contained in the current set of region identifiers,
wherein determining the set of exit regions that the mobile entity is exiting and are to be deallocated from the mobile entity comprises determining each region identifier that is contained in the current set of region identifiers and that is not contained in the next set of region identifiers, and
setting the entity location variable to the set identifier of the next node.

10. The system of claim 8, wherein, in response to obtaining a definition of two or more regions in the simulation space, the method comprises, for each region:
for each node contained in the region,
when a value stored for the node in the first data structure is a predetermined identifier indicating that the node is not contained in any one of the two or more regions, generating a set comprising the region identifier of the region,
when the value stored for the node in the first data structure is a region set identifier, generating a set comprising i) the region identifier of the region and ii) a set of region identifiers retrieved from the second data structure and corresponding to the region set identifier,
when the generated set is found in the third data structure,
storing, for the node, in the first data structure, a set region identifier retrieved from the third data structure and corresponding to the generated set; and,
when the generated set is not found in the third data structure,
storing the generated set in a new element of the second data structure,
storing, for the node, in the first data structure, a new region set identifier comprising an index to the new element of the second data structure, and
associating the generated set in the third data structure to the new region set identifier.

11. The system of claim 7, wherein the performing comprises, when the mobile entity is moving from the current node to the next node along a diagonal of the grid of nodes,
determining two or more intermediate nodes between the current node and the next node, and
when at least one of the two or more intermediate nodes has a region set identifier different from the region set identifier of the current node and the next node,
retrieving, for each intermediate node, a set of regions associated with the region set identifier of the intermediate node, and
when the retrieved set is not contained in the set of regions associated with the region set identifier of the next node, adding the retrieved set to a diagonal set of region identifiers,
wherein determining the set of enter regions that the mobile entity is entering and are to be allocated to the mobile entity further comprises determining each region identifier that is contained in the diagonal set of region identifiers and that is not contained in the current set of region identifiers, and
wherein determining the set of exit regions that the mobile entity is exiting and are to be deallocated from the mobile entity further comprises determining each region identifier that is contained in the diagonal set of region identifiers and that is not contained in the next set of region identifiers.

12. The system of claim 7, wherein obtaining the computer data comprising the definition of the one or more regions comprises receiving a definition of a shape for each of the one or more regions in the simulation space, and wherein the method comprises, in response to receiving the definition of the shape for each of the one or more regions,
determining a bounding box of the shape, and
determining, based on the bounding box, nodes of the grid of nodes contained in the region.
